(19) United States
(12) Patent Application Publication
(10) Pub. No.: US 2024/0161324 A1
(43) Pub. Date: May 16, 2024

(54) INFORMATION PROCESSING DEVICE, IMAGE CAPTURING DEVICE, CLIENT DEVICE, CONTROL METHODS THEREOF, AND NON-TRANSITORY COMPUTER-READABLE STORAGE MEDIUM

(71) Applicant: CANON KABUSHIKI KAISHA, Tokyo (JP)

(72) Inventor: KYOKO MIYAMAE, Kanagawa (JP)

(21) Appl. No.: 18/500,293

(22) Filed: Nov. 2, 2023

(30) Foreign Application Priority Data
Nov. 15, 2022 (JP) 2022-182796

(51) Int. Cl. G06T 7/62; G06T 3/40; G06T 7/20; G06V 10/74

(52) U.S. Cl. CPC G06T 7/62; G06T 3/40; G06T 7/20; G06V 10/761; G06V 2201/07

(57) ABSTRACT

An information processing device which detects a predetermined subject from an image captured, determines a speed at which to change an imaging range in accordance with a subject size of the predetermined subject detected, controls the change in the imaging range at the determined speed, determines the speed such that the imaging range is not changed while the subject size detected takes a value within a first range based on a target size, and when a first difference between a detection limit subject size at which the predetermined subject can be detected and a subject size associated with an edge of the first range is lower than a first predetermined value, and changes the subject size associated with the edge of the first range such that the first difference becomes greater than or equal to the first predetermined value.

### BACKGROUND

### Field of the Disclosure

The disclosure relates to an information processing device, an image capturing device, a client device, control methods thereof, and a non-transitory computer-readable storage medium.

### Description of the Related Art

Video is often distributed and recorded for lectures, sports, and the like. Automatic tracking photography has begun to be put into practical use in recent years to eliminate labor and other costs. In Japanese Patent Laid-Open No. 2013-9435, it is determined whether a subject is within a predetermined region in an imaging range, and if the subject is determined not to be within the predetermined region, the imaging range is zoomed out so as to include the subject.

However, Japanese Patent Laid-Open No. 2013-9435 does not assume performing zoom speed control that takes into account settings for a target size at which the subject is to be imaged, a detection limit size for detecting the subject, and the like, and there is therefore a risk that the subject may be lost depending on the detection limit size.

### SUMMARY

Accordingly, a technique for controlling the zoom according to a target size at which the subject is to be imaged and a detection limit size is provided.

One aspect of embodiments relates to an information processing device comprising, a detection unit configured to detect a predetermined subject from an image captured by an image capturing unit, a determination unit configured to determine a speed at which to change an imaging range of the image capturing unit in accordance with a subject size of the predetermined subject detected, and a control unit configured to control the change in the imaging range of the image capturing unit at the speed determined by the determination unit, wherein the detection unit has a detection limit subject size at which the predetermined subject can be detected, and the determination unit determines the speed such that the imaging range is not changed while the subject size detected takes a value within a first range determined based on a target size, and in a case where a first difference between the detection limit subject size and a subject size associated with an edge of the first range is lower than a first predetermined value, changes the subject size associated with the edge of the first range such that the first difference becomes greater than or equal to the first predetermined value.

Further features of the disclosure will become apparent from the following description of exemplary embodiments (with reference to the attached drawings).

### BRIEF DESCRIPTION OF THE DRAWINGS

FIG. 1 is a diagram illustrating an example of the configuration of a system according to embodiments.

FIG. 2A is a diagram illustrating an example of the functional configuration of a network camera 100 according to embodiments.

FIG. 2B is a diagram illustrating an example of the hardware configuration of a client device 140.

FIG. 3A is a diagram illustrating an example of a user interface according to embodiments.

FIG. 3B is a diagram illustrating a method for setting a target size for a subject according to embodiments.

FIG. 3C is a diagram illustrating an example of a subject selection screen according to embodiments.

FIG. 4A is a diagram illustrating an example of a speed table according to a first embodiment.

FIG. 4B is a diagram illustrating an example of the default state of a speed table 400 before correcting (adjusting) a zoom speed according to the first embodiment.

FIG. 4C is a diagram illustrating an example of the state of a speed table 410 after correcting (adjusting) the zoom speed according to the first embodiment.

FIG. 5A is a flowchart illustrating an example of processing for generating setting information of the network camera 100, performed by the client device 140 according to the first embodiment.

FIG. 5B is a flowchart illustrating an example of processing for setting zoom control information in the flowchart illustrated in FIG. 5A, according to the first embodiment.

FIG. 6 is a flowchart illustrating an example of processing performed by the network camera 100 according to the first embodiment.

FIG. 7A is a diagram illustrating an example of the default state of a speed table 700 before correcting (adjusting) the zoom speed according to a second embodiment.

FIG. 7B is a diagram illustrating an example of the state of a speed table 710 after correcting (adjusting) the zoom speed according to the second embodiment.

FIG. 8 is a flowchart illustrating another example of processing performed by the client device 140 according to the second embodiment.

FIG. 9 is a diagram illustrating an example of the functional configuration of the network camera 100 according to a third embodiment.

FIG. 10A is a diagram illustrating an example of the default state of a speed table 1000 before correcting (adjusting) the zoom speed according to the third embodiment.

FIG. 10B is a diagram illustrating an example of the state of a speed table 1010 after correcting (adjusting) the zoom speed according to the third embodiment.

FIG. 11A is a flowchart illustrating another example of processing performed by the client device 140 according to the third embodiment.

FIG. 11B is a flowchart illustrating another example of processing performed by the network camera 100 according to the third embodiment.

### DESCRIPTION OF THE EMBODIMENTS

Hereinafter, embodiments will be described in detail with reference to the attached drawings. Note, the following embodiments are not intended to limit the scope of the claimed disclosure. Multiple features are described in the embodiments, but limitation is not made to a disclosure that requires all such features, and multiple such features may be combined as appropriate. Furthermore, in the attached drawings, the same reference numerals are given to the same or similar configurations, and redundant description thereof is omitted.

### First Embodiment

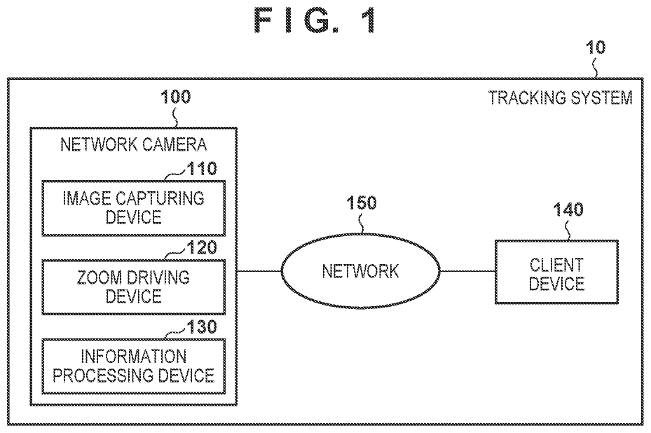

FIG. 1 illustrates an example of the configuration of a tracking system according to the present embodiment. FIG. 1 is a block diagram illustrating an example of the functional configuration of a tracking system 10 according to the present embodiment. The tracking system 10 is constituted by a network camera 100 and a client device 140 being connected and communicating over a network 150. The network camera 100 includes an image capturing device 110, a zoom driving device 120, and an information processing device 130, is configured to be capable of communicating with the client device 140 over the network 150, and may be realized by an image capturing device or a digital video camera having a function for connecting to a network, for example.

In the present embodiment, the network camera 100 controls the operations of the image capturing device 110 and the zoom driving device 120 to capture an image (including still images and moving images; the same applies hereinafter) of a imaging target region based on setting information input from the client device 140. The image obtained by the imaging is then processed by the information processing device 130 and output to the client device 140 over the network 150. The client device 140 is configured including a display device such as a monitor, an input device, a personal computer (PC), and the like as the information processing device, and can accept the input of setting information from a user and output the setting information to the network camera 100 over the network 150. Additionally, the client device 140 can receive the images captured by the network camera 100 over the network 150 and display the images in the display device. Although only a single client device 140 is illustrated in FIG. 1, a plurality of client devices that receive the images may be connected to the network 150. In this case, a distinction may be made between the client device 140 of an administrator who can input the setting information, and the client device 140 for a general user that only receives images.

Although FIG. 1 illustrates a configuration in which only a single network camera 100 is provided, the number of network cameras 100 that can be provided in the tracking system 10 is not limited to one, and more can be provided. Additionally, the settings for each of the plurality of network cameras 100 may be settings specific to the individual network cameras, or may be settings common to the plurality of network cameras.

In the present embodiment, the network camera 100 captures an image of a imaging space and transmits the image to the client device 140 over the network 150. At this time, the network camera 100 detects a predetermined subject in the imaging space, and automatically adjusts the zoom ratio and changes the imaging range such that the size of the subject in the screen takes on a size specified by the client device 140 (“imaging target size” or “target size”). As a result of the zoom control operations, a desired subject will consistently be displayed at a size substantially matching the target size in the image provided to the client device 140. Accordingly, for example, in applications such as live video broadcasts of lectures, a lecturer in the video will be displayed at a substantially constant size, which makes it possible to distribute a stable video.

In the tracking system 10, it is necessary to capture an image of the subject at a size which matches the target size, and thus it is desirable to keep the imaging range constant without controlling the zoom while the subject is being imaged at the target size. On the other hand, if the subject to be detected is moving, the movement may cause the size of the detected subject to fall below or exceed a limit size at which it is possible to determine whether the subject is the predetermined subject (“detection limit size”). If the subject size exceeds the detection limit size, the subject will be unable to be recognized, and if such a state continues for a predetermined length of time, the subject will be determined to have been “lost”.

Accordingly, in the present embodiment, the size of a range of subject sizes over which zoom control is not performed (a dead zone) is adjusted according to a relationship between the dead zone and the detection limit size, which makes it possible to avoid situations where the size of the detected subject exceeds the detection limit size and prevent the subject from being lost.

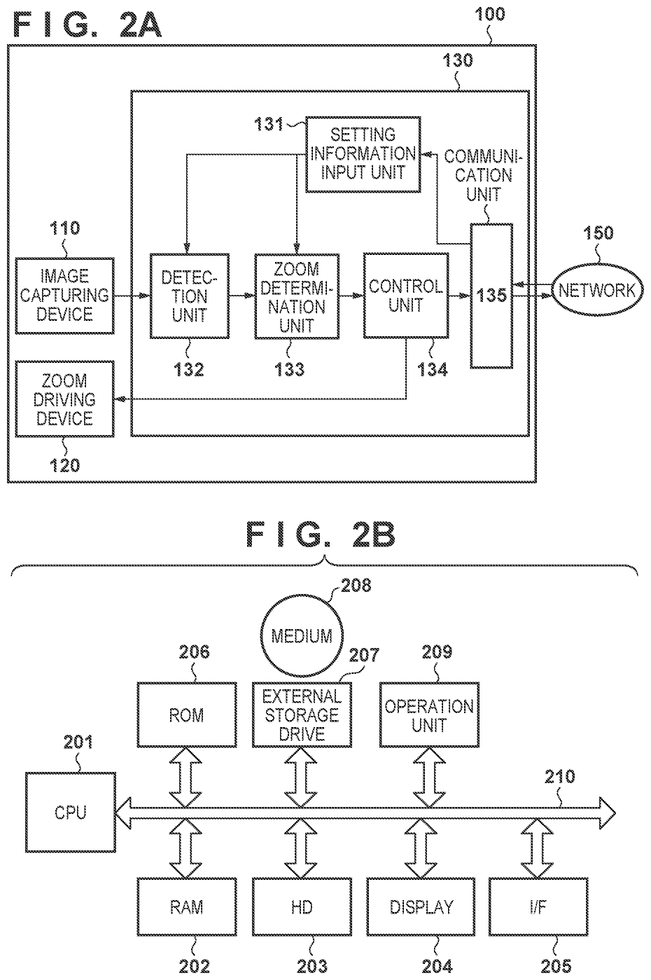

The functional configuration of the network camera 100 according to the present embodiment will be described with reference to FIG. 2A. FIG. 2A is a block diagram illustrating an example of the functional configuration of the network camera 100.

The image capturing device 110 functions as an image capturing unit for imaging the imaging space and outputting an image to the information processing device 130. The image capturing device 110 includes an image sensor such as a CCD or a CMOS sensor, an A/D converter, an image processing unit, and the like, and can output image information. The image capturing device 110 also has a zoom mechanism, which enables the imaging range to be changed. The zoom mechanism is controlled by the zoom driving device 120. The zoom driving device 120 controls the zoom mechanism of the image capturing device 110 to zoom in or zoom out automatically in accordance with control signals from a control unit 134 of the information processing device 130. At this time, the zoom driving device 120 can vary the zoom change speed in accordance with the control signals.

The information processing device 130 controls the operations of the zoom driving device 120 based on the image information generated by the image capturing device 110 and setting information obtained from the client device 140, and adjusts the imaging range such that a subject to be tracked can be imaged at a desired size. The information processing device 130 can function as a tracking device that tracks a subject such that the subject can be imaged at the desired size within the imaging range. The information processing device 130 can be configured including a setting information input unit 131, a detection unit 132, a zoom determination unit 133, the control unit 134, and a communication unit 135.

Although a configuration in which the information processing device 130 is provided within the network camera 100 is illustrated here, of the constituent elements, the detection unit 132, the zoom determination unit 133, and the control unit 134 may be provided on the client device 140 side. In this case, the zoom can be controlled from the client device 140 over the network 150.

The setting information input unit 131 receives the setting information pertaining to the subject imaged by the image capturing device 110 from the client device 140 via the communication unit 135. The received setting information is provided to the detection unit 132 and the zoom determination unit 133. In the present embodiment, the setting information can include at least information designating a tracking target (designation information), the target size, and a speed table for zoom control. The designation information can include, for example, information for specifying a designated subject (if the subject is a person, feature information extracted from the face of the person or the like). This information is used for subject detection. Additionally, if one or more subjects are present in the image captured by the image capturing device 110, the designation information can be information designating one of those subjects. In this case, numbers can be assigned to the detected subjects in advance, and a selected number can be included in the designation information. Alternatively, the designation information may be information designating the location, region, or the like where the subject to be tracked is present in the screen. The speed table is information in a table that specifies zoom speeds according to the size of the detected subject. If the zoom determination unit 133 determines that it is necessary to change the zoom based on the size of the detected subject, the zoom speed corresponding to the current subject size can be selected by referring to the speed table and then communicated to the control unit 134. The designation information may further include other information such as the position of the subject being tracked in the screen, a standard for determining that the tracking target has been lost (e.g., how many seconds the subject cannot be detected before being determined to be lost), and the like.

Based on the setting information input from the setting information input unit 131, the detection unit 132 analyzes the image information input from the image capturing device 110, detects the subject to be tracked, and outputs detection information to the zoom determination unit 133. In the present embodiment, the detection information output to the zoom determination unit 133 is assumed to include at least information on the size of the subject to be tracked in the screen, but may also include other information, such as information on the position of the subject to be tracked, a detection accuracy, and the like.

If the zoom determination unit 133 determines that it is necessary to change the zoom based on the size of the subject detected by the detection unit 132, the zoom speed corresponding to the current subject size can be selected by referring to the speed table and then communicated to the control unit 134. The image information provided from the detection unit 132 is also output to the control unit 134. Upon obtaining a zoom speed designation from the zoom determination unit 133 and the image information, the control unit 134 outputs a control signal for zoom driving to the zoom driving device 120 in accordance with the designated zoom speed. The image information is also output to the communication unit 135. The zoom driving device 120 operates the zoom mechanism of the image capturing device 110 to change the zoom ratio in accordance with the input control signal. The communication unit 135 transmits the obtained image information to the client device 140 over the network 150. The setting information received from the client device 140 is also provided to the setting information input unit 131.

An example of the hardware configuration of the client device 140 will be described next with reference to FIG. 2B. The client device 140 can be realized as an information processing device such as, for example, a personal computer (PC), a smartphone, a tablet terminal, or the like. In FIG. 2B, a CPU 201 executes an OS, application programs, and the like stored in a hard disk (HD) 203, and controls the temporary storage of information, files, and the like required to execute programs in a RAM 202. The RAM 202 functions as the main memory, a working area, and so on for the CPU 201. The HD 203 stores application programs, driver programs, the OS, control programs, processing programs for executing processing corresponding to the present embodiment, and the like.

A display 204 is a display device for displaying commands input from an operation unit 209, information obtained from the exterior, and the like. An interface (“I/F” hereinafter) 205 is a communication interface for connecting to external devices, networks, and the like. Programs such as a basic I/O program are stored in a ROM 206.

An external storage drive 207 can load programs and the like stored in a medium 208 into the computer system. The medium 208, which is a recording medium, stores predetermined programs and related data. The operation unit 209 is a user interface through which an operator of the device inputs instructions, and is constituted by a keyboard, a mouse, and the like. A system bus 210 handles the flow of data within the device.

Although FIG. 2B illustrates an example of the hardware configuration of the client device 140, the hardware configuration of the information processing device 130 in the network camera 100 can be implemented in the same manner as the configuration illustrated in FIG. 2B. In other words, the functions of the setting information input unit 131, the detection unit 132, the zoom determination unit 133, and the control unit 134 can be realized by the configuration of the CPU 201, the RAM 202, the HD 203, the ROM 206, and the system bus 210. In other words, the functions may be realized by the CPU 201 executing predetermined programs stored in the ROM 206 and the HD 203, and temporarily storing information, files, and the like required to execute the programs in the RAM 202. The communication unit 135 is also implemented as the interface 105. The flowcharts of the processing by the network camera 100 described below can also be realized by this configuration.

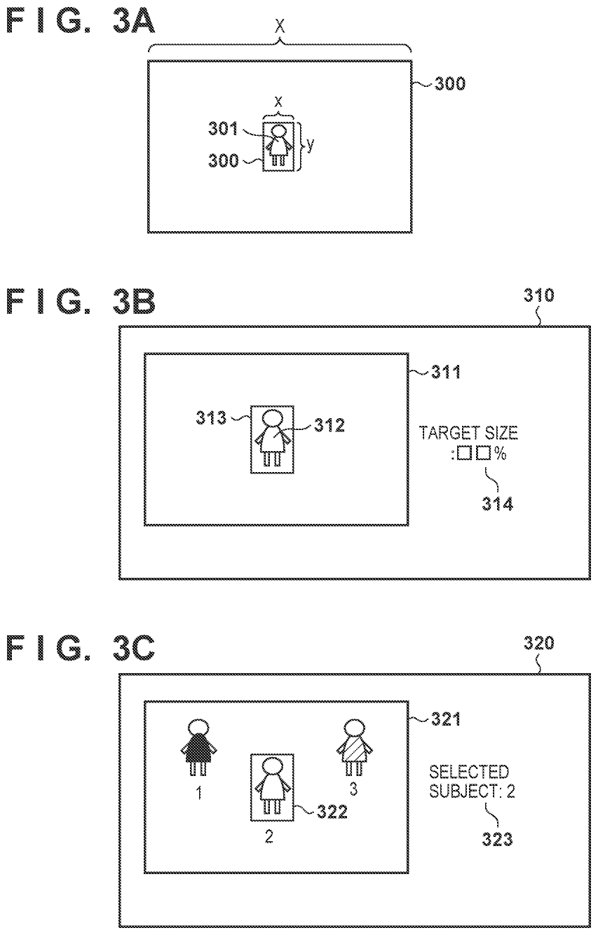

The concept of the subject size, a method for setting the target size, and the method for designating the subject according to the present embodiment will be described next with reference to FIGS. 3A to 3C.

In the present embodiment, a size, in a width direction, of a subject region 302 surrounding a subject 301 is indicated by “x”, with respect to a size “X”, in the width direction, of a screen 300, as indicated in FIG. 3A. Here, in the present embodiment, the size at which the detection unit 132 can detect the subject is referred to as the “detection limit size”, as mentioned above. To detect a specific subject from an image, a certain size is necessary in order to identify information of that subject. For example, it is difficult to specify the subject if the size of the detected subject is too small, or if the size is too large and only some of the information of the subject is included in the image. There will thus be a minimum size DLmin and a maximum size DLmax at which each detection unit 132 can detect a subject.

In the present embodiment, the subject size is expressed as “x/X”, with the subject size at which x/X=DLmin being the detection limit size in a minimum direction. Likewise, the subject size at which x/X=DLmax is the detection limit size in a maximum direction. DLmin can be, for example, 0.06, i.e., 6%, and DLmax can be, for example, 0.8, i.e., 80%. However, these are only examples, and the detection limit size can be set according to the screen size (number of pixels), the detection performance of the detection unit 132, and the like.

In the present embodiment, the subject region 302 can be a rectangular region surrounding the region of the subject 301, and the subject size can be the width of the subject region 302. Alternatively, if the subject 301 is a person, the person can be identified by their face, and the detection size can therefore be the width of the face or head of the detected subject 301.

In the present embodiment, the subject is assumed to be a person, and the person is recognized and identified by their face. Therefore, if the face can be determined, the person can also be identified, and in this sense, it is sufficient as long as the face is large enough. In addition to the face, the person may be identified based on, for example, their clothing, height, body type, or the like. The following will describe a case where the subject size and the detection limit size are taken as the width of the detected subject or the subject region. As such, the value of a height “y” of the subject region is not included in the determination of the detection limit. However, depending on the target of the determination, the detection limit may be determined based on the magnitude of the value of the height “y” of the subject region, a ratio of the width “x” to the height “y”, or the like. In this case too, the following descriptions for the width only can be applied in the same manner.

A method for setting the target size of the subject will be described next with reference to FIG. 3B. In FIG. 3B, a captured image 311 is displayed in a screen 310, the captured image 311 has a size corresponding to the imaging range, a subject 312 appears in the captured image 311, and a frame 313 indicating the subject region for determining the subject size is displayed so as to surround the subject 312. Here, the value of the “target size” can be input in an input region 314 as a target value for the size of the detected subject. At this time, the size of the subject region 313 in the display of the screen 310 may be controlled so as to change in accordance with the input value.

If the value of the detection limit size is determined in advance, control may be performed such that the value which can be input as the target size does not fall below (exceed) the detection limit size. Alternatively, control may be performed so as to permit the input of a value higher than a predetermined value above the detection limit size.

FIG. 3C illustrates an example of a subject selection screen. In FIG. 3C, a captured image 321 is displayed in a screen 320, and people 1, 2, and 3 recognized as subjects appear in the image. Which of these is to be taken as the target of detection can be designated in an input region 323. FIG. 3C illustrates a case where the subject 2 is designated, and a frame 322 indicating that the subject 2 is designated is displayed around the subject 2. Although FIG. 3C illustrates a case where one subject is selected when a plurality of subjects appear, if only a single subject appears, that single subject may be automatically taken as the target for detection.

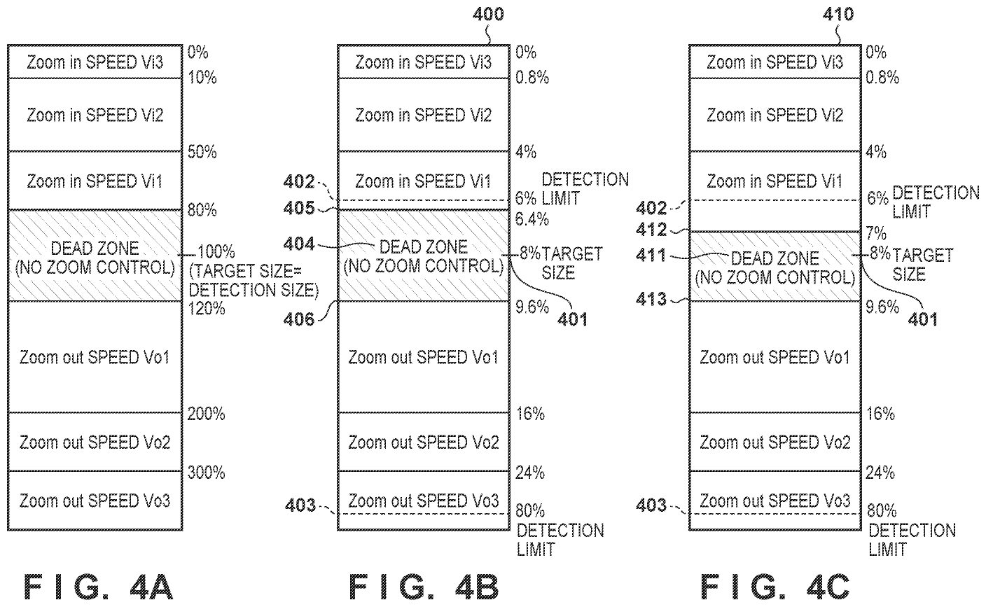

Zoom speed settings according to the present embodiment will be described next with reference to FIGS. 4A to 4C. The zoom determination unit 133 performs processing for determining the zoom speed based on the size of the subject to be tracked, input from the detection unit 132, and information on the target size in the setting information input from the setting information input unit 131. In the present embodiment, zoom control is performed so as to change the zoom speed in steps, such that the zoom speed becomes slower as the difference between the subject size in the image information captured by the image capturing device 110 and the target size which has been set decreases, and the zoom speed is kept at 0, i.e., the imaging range is not changed, when the subject size is near the target size.

Specifically, the present embodiment will describe a case where a speed table which defines correspondence relationships between subject sizes and zoom speeds as defaults, as illustrated as an example in FIG. 4A, is prepared, and zoom control is performed in seven steps according to the ratio of the subject size to the target size. According to the speed table, a zoom speed can be assigned to each subject size in advance based on the target size.

In FIG. 4A, a case where the size of the detected subject matches the target size is indicated as “100%”. Zoom control is not performed when the deviation between the target size and the subject size is within a range of ±20% of the target size. A zoom-in speed Vi is increased as the ratio of the subject size to the target size decreases. In FIG. 4A, Vi1 is used when the subject size is in a range of 80% to 50% of the target size; Vi2, when the subject size is in a range of 50% to 10%; and Vi3, when the subject size is in a range below 10%. At this time, the magnitude relationship among the zoom-in speeds is Vi1<Vi2<Vi3.

Similarly, a zoom-out speed Vo is increased as the ratio of the subject size to the target size increases. In FIG. 4A, Vo1 is used when the subject size is in a range of 120% to 200% of the target size; Vo2, when the subject size is in a range of 200% to 300%; and Vo3, when the subject size is in a range above 300%. At this time, the magnitude relationship among the zoom-out speeds is Vo1<Vo2<Vo3.

In this manner, in the present embodiment, the zoom speed is controlled to accelerate as the subject size moves away from the target size. Although FIG. 4A indicates the zoom speed as being switched in three steps both when zooming in and zooming out, the zoom speed may be switched in two steps, or in four or more steps, as long as the zoom speed is switched in a plurality of steps. Additionally, the default settings are not limited to those illustrated in FIG. 4A, and the settings can be changed flexibly in accordance with the environment in which the system is applied.

Near the target size (a range of ±20% of the target size), the zoom speed is set to 0 and the imaging range is not changed. This range, in which zoom control is not performed, will be called a “dead zone” in the present embodiment. When the subject size is within the “dead zone” range, if the subject to be detected moves in a direction away from the network camera 100 (a direction in which the detection size becomes smaller), zoom control is performed to zoom in and bring the subject size closer to the target size if the subject size decreases so as to exceed the dead zone. At this time, if a subject size associated with an edge of the dead zone is near or adjacent to the detection limit size, or if the target size is set to be near the detection limit size, there is a risk that the subject size will drop below the detection limit size at the timing at which the subject size decreases so as to exceed the dead zone range and an attempt is made to start zooming in. In this manner, if the subject detection size drops below the detection limit size, the likelihood of losing the subject increases, and it is therefore necessary to perform control such that the size does not fall below the detection limit.

Accordingly, in the present embodiment, when a difference between the dead zone range and the detection limit size (a first difference; D1) is lower than a first threshold (Dth1) or a first predetermined value, the dead zone range is narrowed to keep the difference between the dead zone range and the detection limit above a certain level and prevent the subject from being lost. This processing can be performed, for example, when the target size is set in the user interface illustrated in FIG. 3B. Here, the magnitude of the threshold can be set as desired by the user. Alternatively, default thresholds may be prepared according to the type of the detection target (person, vehicle, or the like), and depending on the type of the detection target selected by the user, a threshold associated with the selected type may be used.

A method for controlling the zoom speed according to the present embodiment will be described with reference to FIGS. 4B and 4C. FIGS. 4B and 4C are diagrams illustrating a method for correcting zoom control according to the present embodiment. FIG. 4B illustrates a default state of a speed table 400 before correcting (adjusting) the zoom speed, whereas FIG. 4C illustrates a state of a speed table 410 after correcting (adjusting) the zoom speed. In FIGS. 4B and 4C, the percentage numbers on the vertical axis indicate the subject size. Here, as an example, the target size is 8%, the detection limit size is 6%, and the first threshold serving as a reference for determining whether to adjust the dead zone is 1%.

In FIGS. 4B and 4C, the percentage numbers on the right side indicate the subject size, and a subject size 401 indicates a size corresponding to a target size set by the user. A subject size 402 indicates a size corresponding to a minimum detection limit size in the detection unit 132, whereas a size 403 indicates a maximum detection limit size in the detection unit 132. Reference numerals 404 and 411 indicate the dead zone where the zoom speed is 0, whereas a subject size 405 and a subject size 412 indicate the subject sizes at the minimum-side edges of the zoom dead zone. A subject size 406 and a subject size 413 indicate the subject sizes at the maximum-side edges of the zoom dead zone.

In the present embodiment, a difference in the detection size between a subject size 502 corresponding to the minimum detection limit size and the subject size 405 at the minimum-side edge of the dead zone 404 (the first difference; D1) is calculated and compared with the first threshold (Dth1; 1%, in the example described above). At this time, if the first difference is lower than the first threshold, the subject size 405 at the minimum-side edge of the dead zone 404 is corrected such that the first difference becomes at least the threshold. When the correction value for the size 405 is represented by “m”, the subject size 412 on the minimum-side edge of the dead zone 411 after the correction is obtained through the following Formula 1.

subject size 412=subject size 402+m Formula 1

For example, in FIG. 4B, the first difference between the subject size 402 corresponding to the minimum detection limit size and the subject size 405 on the minimum-side edge of the dead zone 404 is 0.4%, which is lower than the set first threshold of 1%. Accordingly, the threshold of 1% is added to the size of 6% of the subject size 402 on the minimum-side detection limit, resulting in the subject size 412 on the minimum-side edge of the dead zone 411 being 7% after the correction.

In this manner, the default speed table 400 illustrated in FIG. 4B is corrected to the speed table 410 illustrated in FIG. 4C by modifying the association between the zoom speed and the subject size. The speed table 410 is provided to the network camera 100 from the client device 140. Referring to the speed table 410, the zoom determination unit 133 designates a zoom speed of 0 in the zoom speed designation output to the control unit 134 while the size the subject detected by the detection unit 132 falls within the dead zone 411. However, if the subject size drops below 7%, the zoom speed is switched from 0 to Vi1, and a control signal designating that zoom speed is transmitted to the control unit 134.

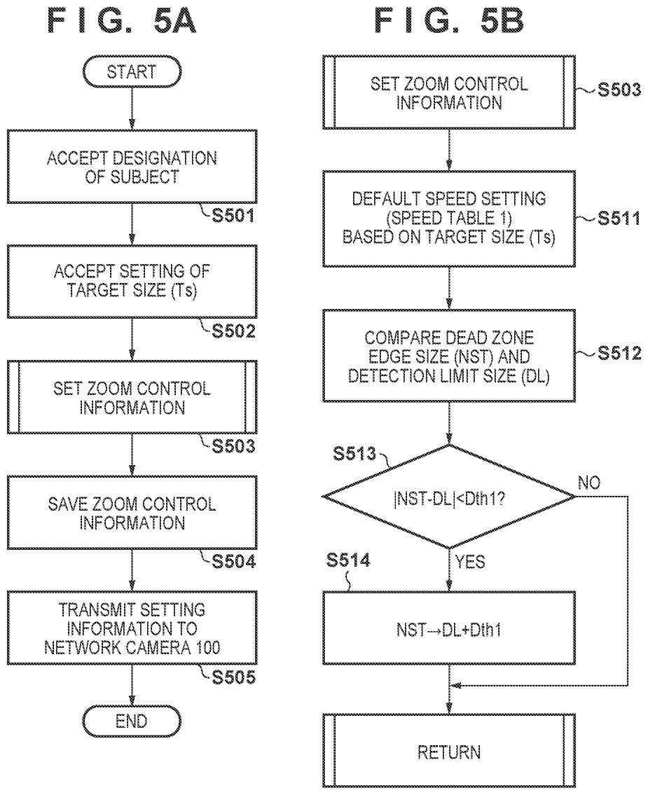

An example of the processing by the tracking system 10 according to the present embodiment will be described next with reference to the flowcharts in FIGS. 5A and 5B. FIG. 5A is a flowchart illustrating an example of processing for generating the setting information of the network camera 100, performed by the client device 140. FIG. 5B is a flowchart illustrating an example of processing for setting the zoom control information in the flowchart illustrated in FIG. 5A. The processing corresponding to the flowcharts can be realized by, for example, the CPU 201 operating in the client device 140 executing corresponding programs (which are stored in the HD 203 or the like).

First, in step S501, the CPU 201 accepts the designation of a subject from the user through the operation unit 209. At this time, the CPU 201 can display the screen 320 illustrated in FIG. 3C in the display 204 with information identifying the subject detected by the CPU 201 or the detection unit 132 superimposed on the image captured by the image capturing device 110, and accept the selection of any displayed subject. Upon accepting the designation of the subject, the CPU 201 extracts and stores information expressing features of the subject (the feature information).

Then, in step S502, the CPU 201 accepts the setting of the target size (Ts) of the detected subject from the user through the operation unit 209. At this time, the screen 310 illustrated in FIG. 3B can be displayed in the display 204, and the input of the target size can be accepted.

After the input of the target size is accepted, in step S503, the CPU 201 sets the zoom control information and generates the speed table. The processing performed in step S503 will be described in detail later with reference to FIG. 5B. After the zoom control information is set, in step S504, the CPU 201 saves the set zoom control information, and then, in step S505, the CPU 201 transmits information specifying the subject, including the aforementioned feature information, as well as setting information including the target size (Ts) and the zoom control information, to the network camera 100.

The processing performed in step S503 will be described in detail next with reference to FIG. 5B. First, in step S511, the CPU 201 sets the default zoom speed (speed table 1) based on the target size (Ts). The example of the settings in speed table 1 correspond to the speed table 400 illustrated in FIG. 4B, for example. Additionally, when the target size (Ts) is set, the subject size (NST) on the minimum-side edge of the dead zone can be specified. Because the minimum side (the subject size 405 in FIG. 4B) is mainly discussed here, the descriptions of which end is which will be omitted hereinafter for the sake of simplicity. Although the descriptions are omitted in the present embodiment, the relationship between the subject size 406 on the minimum-side edge and the subject size 403 corresponding to the detection limit size can be handled in the same manner.

Next, in step S512, the CPU 201 compares the subject size on the edge of the dead zone (NST), specified from the target size (Ts), with a subject size (DL) corresponding to the detection limit. If the comparison indicates that the absolute value of the first difference between NST and DL (D1) is lower than a first threshold Dth1 (“YES” in step S513), the processing moves to step S514. On the other hand, if the first difference D1 is greater than or equal to the threshold Dth1 (“NO” in step S513), this processing ends, and the sequence moves to step S504. In this case, the speed table 1 set in step S511 is not modified, and the content of the speed table 1 is saved as-is as the zoom control information.

In step S514, the CPU 201 corrects the speed table 1. Specifically, the value of the subject size (NST) at the edge of the dead zone in the speed table 1 is updated to a value obtained by adding the first threshold Dth1 to the subject size (DL) corresponding to the detection limit. Here, the value to be added may be a value different from the threshold Dth1. As a result, the situation changes from one in which the subject size 405 at the edge of the dead zone is adjacent to the subject size 402 corresponding to the detection limit, such as that illustrated in FIG. 4B, to one in which the subject size 412 at the edge of the dead zone is located a set distance from the subject size 402 corresponding to the detection limit, such as that illustrated in FIG. 4C. As a result of this correction, the speed table 1 as a default, illustrated in FIG. 4B, is changed to a corrected speed table 2, illustrated in FIG. 4C. The sequence then moves to step S504, where the content of the corrected speed table 2 is saved as the zoom control information. Note that the processing illustrated in FIG. 5B may be executed not on the client device 140 side, but on the network camera side, in response to the target size setting information being received.

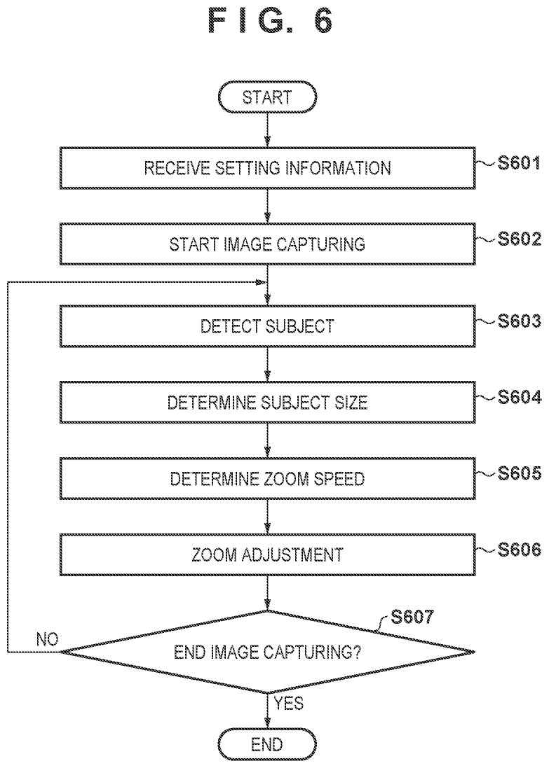

Processing performed on the network camera 100 side according to the present embodiment will be described next with reference to the flowchart in FIG. 6. The processing corresponding to this flowchart can be realized, for example, by at least one processor in the network camera 100 executing a corresponding program (which is stored in the RAM, the HD, or the like).

In step S601, the communication unit 135 of the network camera 100 receives the setting information from the client device 140 over the network 150. The communication unit 135 supplies the received setting information to the setting information input unit 131. The setting information input unit 131 provides information for identifying the subject, among the received setting information, to the detection unit 132. Additionally, information on the target size and the zoom control information are provided to the zoom determination unit 133.

Then, in step S602, when imaging is started, the image capturing device 110 provides the image information, obtained by imaging the imaging region, to the detection unit 132 of the information processing device 130. In step S603, the detection unit 132 detects a subject based on the information for identifying the subject, provided from the setting information input unit 131. The information on the detected subject is provided to the zoom determination unit 133 along with the image information. Although not discussed in the descriptions of the steps provided below, the image information is provided to the communication unit 135 through the zoom determination unit 133 and the control unit 134, and is then transmitted from the communication unit 135 to the client device 140 over the network 150.

The zoom determination unit 133 determines the subject size based on the information on the subject provided from the detection unit 132 in step S604. Then, in step S605, the zoom determination unit 133 determines the zoom speed in accordance with the zoom control information provided from the setting information input unit 131, based on the relationship between the subject size and the target size. Using the example in FIG. 4C, the zoom speed is set to 0 while the size of the detected subject falls within a range of 9.6% to 7% of the screen width. Then, for a zoom-in operation, the zoom speed is set to Vi1 when the subject size is between 7% and 4%; to Vi2, when the subject size is between 4% and 0.8%; and to Vi3, when the subject size is lower than 0.8%. Similarly, for a zoom-out operation, the zoom speed is set to Vo1 when the subject size is between 9.6% and 16%; to Vo2, when the subject size is between 16% and 24%; and to Vo3, when the subject size is greater than 24%.

Then, in step S606, the zoom determination unit 133 provides the determined zoom speed to the control unit 134, and the control unit 134 controls the zoom driving device 120 to operate at the designated zoom speed. Then, in step S607, it is determined whether the imaging is to end; if it is determined that the imaging is to end (“YES” in step S607), this processing ends, whereas if it is determined that the imaging is not to end (“NO” in step S607), the processing returns to step S603 and continues.

In the present embodiment described above, if the subject size at the edge of the dead zone is located near the subject size at the detection limit as illustrated in FIG. 4B, the subject size corresponding to that image is adjusted to change the range of the dead zone. Here, for example, if, when the setting of the target size is accepted in step S502, the subject size at the edge identified based on the input target size is determined to be located near the subject size at the detection limit, a message to that effect may be displayed to communicate that the range of the dead zone will be changed. At this time, if the user who has confirmed the message provides an operation instruction indicating they do not wish to change the range of the dead zone, the change of the range of the dead zone can also be skipped.

Additionally, control may be performed so as not to permit the input of a target size that will result in the range of the dead zone being changed as described above, or to permit the input after displaying the aforementioned message. Specifically, a lower limit input value for the target size may be specified based on the relationship between the subject size at the edge of the dead zone and the subject size at the detection limit, and only values greater than the lower limit input value may be accepted for the target size.

In the example in FIG. 4B, the subject size 402 at the detection limit is 6%. In order to set the subject size 405 at the edge of the dead zone to be distanced from the detection limit by the first threshold (Dth1=1%), i.e., 7%, it is necessary to set the target size to 8.75%. In this case, control may be performed so as only to accept the input of values greater than 8.75% as the target size. Alternatively, if a target size lower than 8.75% has been input, the input may be accepted after displaying a message or a warning indicating that the range of the dead zone will be narrowed or that the likelihood of the subject being lost will increase.

As described thus far, according to the present embodiment, changing the range of the dead zone when the set target size is near the detection limit size for the subject increases the zoom speed beyond the default setting in advance at the detection limit. This makes it possible to reduce the likelihood of the subject being lost due to a detection failure by using a faster zoom speed at the detection limit.

### Second Embodiment

A second embodiment will be described hereinafter. The system configuration corresponding to the present embodiment is the same as that illustrated in FIG. 1, and will therefore not be described here. The first embodiment described a case where the zoom speed is changed from the default speed table 1 to the speed table 2 based on the relationship between the subject size at the edge of the dead zone and the subject size corresponding to the detection limit. The present embodiment will describe, as an alternative embodiment to the first embodiment or as an additional embodiment, a case where the zoom speed is changed from the default value based on a relationship between a size for a switch in the zoom speed and the detection limit size.

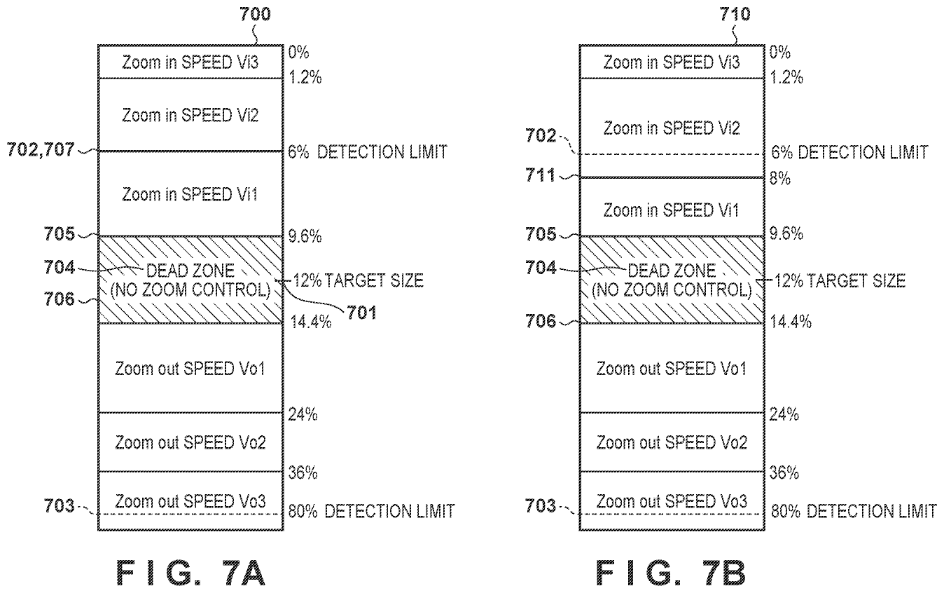

FIGS. 7A and 7B are diagrams illustrating a method for correcting the zoom speed according to the present embodiment. Reference numbers other than those described below in association with FIGS. 7A and 7B represent contents of reference numbers having the same last two digits of FIGS. 4B and 4C. FIG. 7A illustrates a default state of a speed table 700 before correcting (adjusting) the zoom speed, whereas FIG. 7B illustrates a state of a speed table 710 after correcting (adjusting) the zoom speed. In FIGS. 7A and 7B, the percentage numbers on the vertical axis indicate the subject size. In FIGS. 7A and 7B, the target size is set to 12%, and the detection limit size is set to 6%. Additionally, a second threshold (Dth2), which serves as a reference for determining whether to adjust the subject size at which to switch the zoom speed, or a second predetermined value, is set to 2%.

First, in FIG. 7A, when the target size (Ts) is set to 12%, a range of 9.6% to 14.4% of the subject size is set as a dead zone 704 in accordance with the method for calculating the default zoom speed illustrated in FIG. 4A. The zoom-in speed of Vi1 is associated with a subject size range of 9.6% to 6%. Additionally, Vi2 is associated with subject sizes from 6% to 1.2%. At this time, the zoom-in speed is switched at a subject size of 6% (707), which matches the subject size at the detection limit 702.

In this case, if the subject moves away from the network camera 100 at a speed higher than the zoom speed of Vi1, is meaningless to increase the zoom-in speed after the subject size reaches the detection limit. Accordingly, the subject size at which the zoom-in speed is switched is changed so as to make the timing of the switch from the zoom-in speed Vi1 to Vi2 earlier in advance. In FIG. 4B, the zoom-in speed is changed from Vi1 to Vi2 at the point in time when the detection size of the subject reaches 8% (711). This makes it possible to more reliably capture an image of the subject continuously at the target size, without the subject being lost.

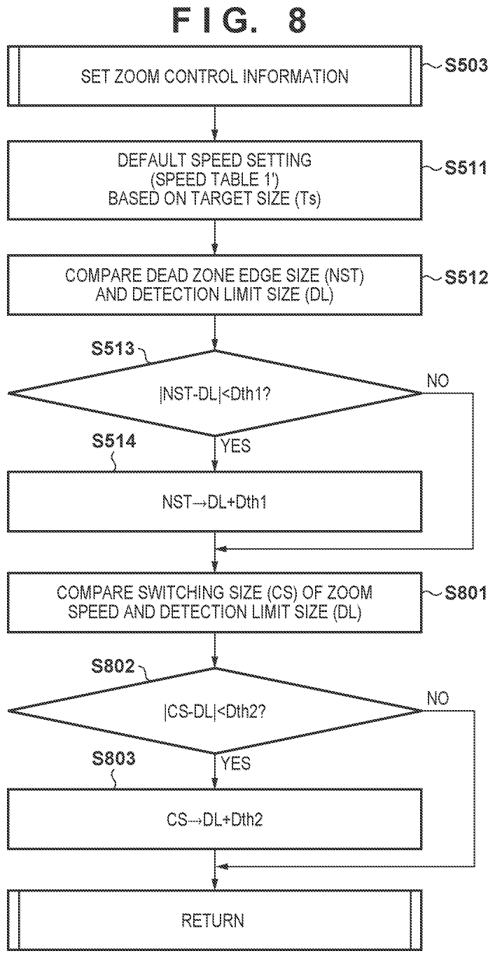

The processing by which the client device 140 generates the setting information for the network camera 100 according to the present embodiment is similar to that illustrated in FIG. 5A. However, in the present embodiment, the specifics of the processing for setting the zoom control information in step S503 are different, and will therefore be described with reference to FIG. 8.

FIG. 8 is a flowchart corresponding to an example of the processing for setting the zoom control information performed in step S503 of FIG. 5A. The processing performed in steps given reference numerals from S511 to S514 in FIG. 8 is the same as that illustrated in FIG. 5B, and will therefore not be described here. After step S514, in step S801, the CPU 201 compares a subject size (CS) at a zoom speed switching position with the subject size (DL) at the detection limit. If there are a plurality of sizes at the zoom speed switching position, the comparison is made with each of those sizes.

Then, in step S802, if the absolute value of a difference (a second difference; D2) between the size (CS) at the switching position and the subject size (DL) at the detection limit is greater than or equal to a second threshold Dth2 (“NO” in step S513), the sequence ends. On the other hand, if the absolute value of the difference D2 is lower than the second threshold Dth2 (“YES” in step S513), the sequence moves to step S803.

In step S803, the CPU 201 updates the subject size (CS) at the switching position to a value obtained by adding the second threshold Dth2 to the subject size (DL) at the detection limit. Here, the value to be added may be a value different from the second threshold Dth2. As a result, the situation changes from one in which the subject size (CS) at the zoom speed switching position is adjacent to the subject size (DL) at the detection limit, such as that illustrated in FIG. 7A, to one in which the subject size (CS) at the switching position is located a set distance from the subject size (DL) at the detection limit, such as that illustrated in FIG. 7B. As a result of this correction, the speed table 1′ as a default, illustrated in FIG. 7A, is changed to a corrected speed table 2′, illustrated in FIG. 7B. Although the zoom speed correction corresponding to the first embodiment is not performed in FIG. 7B, the zoom speed correction of the first embodiment can also be performed as long as a condition is satisfied in the processing from steps S511 to S514 according to the flowchart in FIG. 8. The processing illustrated in FIG. 8 may also be executed not on the client device 140 side, but on the network camera side, in response to the target size setting information being received.

The information in the speed table 2′, for the zoom speed updated in this manner, is saved by the CPU 201 as the zoom control information in step S504, and is transmitted as the setting information to the network camera 100 along with other information in step S505.

In the present embodiment too, the network camera 100 can execute processing according to the flowchart in FIG. 6, and at that time, the setting information received by the communication unit 135 of the network camera 100 from the client device 140 over the network 150 includes the above-described zoom control information corresponding to the present embodiment. The communication unit 135 supplies the received setting information to the setting information input unit 131. The setting information input unit 131 provides the information on the target size and the zoom control information, among the received setting information, to the zoom determination unit 133. The zoom determination unit 133 determines the subject size based on the information on the subject provided from the detection unit 132 in step S604, and determines the zoom speed according to the subject size by referring to the zoom control information provided from the setting information input unit 131 in step S605. Other aspects are identical to the first embodiment.

Using the example in FIG. 7B, the zoom speed is set to 0 while the size of the detected subject falls within a range of 14.4% to 9.6% of the screen width. Then, for a zoom-in operation, the zoom speed is set to Vi1 when the subject size is between 9.6% and 8%; to Vi2, when the subject size is between 8% and 1.2%; and to Vi3, when the subject size is lower than 1.2%. This makes it possible to perform zoom control by shifting the subject size at the timing for switching the zoom-in speed from the subject size at the detection limit, which in turn makes it possible to more reliably track the subject within the detection limit.

As described thus far, according to the present embodiment, when the subject size at the zoom speed switching position, which is specified based on the set target size, is close to the subject size at the detection limit, situations where the subject is lost due to detection failure can be reduced by increasing the zoom speed near the detection limit.

### Third Embodiment

A third embodiment will be described next. In the above-described first embodiment and second embodiment, the zoom speed was not controlled taking into account the movement speed of the subject. In contrast, zoom control is performed taking into account the movement speed of the subject in the present embodiment.

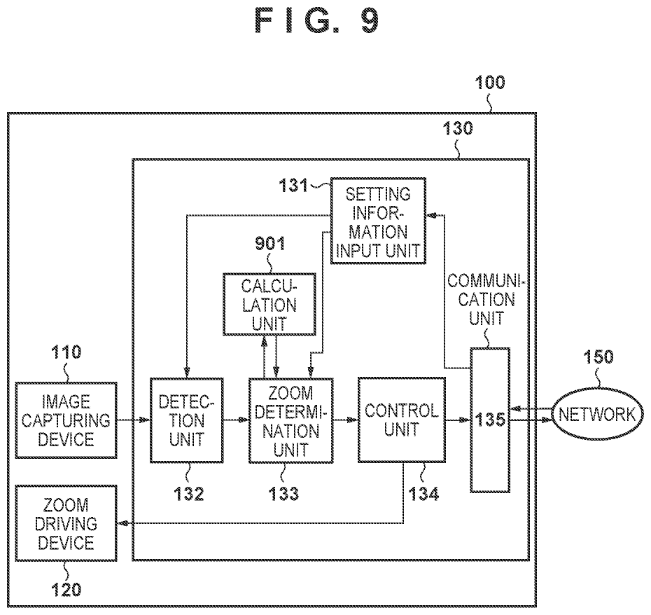

The configuration of the network camera 100 according to the present embodiment is as illustrated in FIG. 9. Constituent elements corresponding to the constituent elements illustrated in FIG. 2A are given the same reference numerals. The network camera 100 includes a calculation unit 901 as a new constituent element in the present embodiment.

The calculation unit 901 calculates a subject speed based on changes in the subject among a plurality of frames in the obtained image information. The subject speed can be calculated as the average of a subject size change rate, from a subject size history extending n frames previous to the current frame. Alternatively, the subject speed can be obtained by dividing a movement amount in a center of gravity position of a subject region, for n frames previous to the current frame, by time. The method for calculating the subject speed is not intended to be limited to the aforementioned methods. The subject speed may be calculated using a method aside from the foregoing methods, as long as the speed at which the subject moves toward or away from the network camera 100, or the speed at which the subject moves forward or backward, can be determined.

Operations performed by the information processing device 130 according to the present embodiment will be described hereinafter. The zoom determination unit 133 determines the zoom speed based on the size of the subject detected by the detection unit 132. The method for determining the zoom speed is the same as that described in the first embodiment, and will therefore not be described here. In addition to this method, the present embodiment has a characteristic in that the speed table used to determine the zoom speed is switched in accordance with the subject speed, as will be described below.

The zoom determination unit 133 calculates the first difference (D1) between the subject size corresponding to the detection limit and the subject size at the edge of the dead zone, and determines whether the difference is greater than or equal to a third threshold Dth3. Here, the third threshold Dth3 or a third predetermined value can be set to a value higher than that of the first threshold Dth1. If the difference is greater than or equal to the third threshold Dth3, the information on the subject size is output to the calculation unit 901. When the information on the subject size is input, the calculation unit 901 determines whether the subject size is smaller than a predetermined subject determination size based on the setting information input from the setting information input unit 131, and if the size is determined to be smaller, calculates a subject speed v. The calculation unit 901 provides information on the calculated subject speed v to the zoom determination unit 133, and the zoom determination unit 133 determines the zoom speed based on the value of the subject speed v.

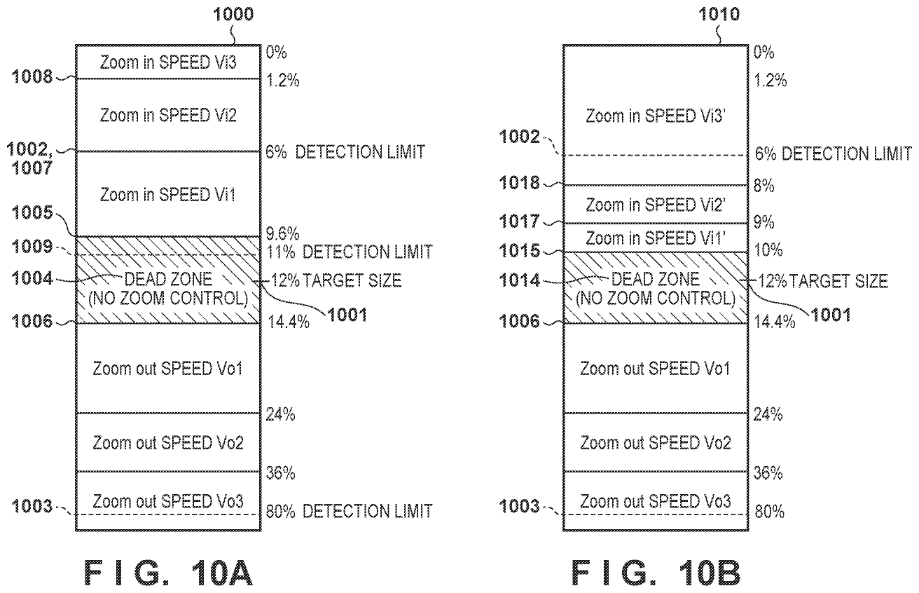

FIGS. 10A and 10B are diagrams illustrating a method for correcting the zoom speed according to the present embodiment. FIG. 10A illustrates a default state of a speed table 1000 before correcting (adjusting) the zoom speed, whereas FIG. 10B illustrates a state of a speed table 1010 after correcting (adjusting) the zoom speed. In FIGS. 10A and 10B, the percentage numbers on the vertical axis indicate the subject size. In FIGS. 10A and 10B, the target size is set to 12%, and the detection limit size is set to 6%.

First, in FIG. 10A, when the target size (Ts) is set to 12%, a range of 9.6% to 14.4% of the subject size is set as a dead zone 1004 in accordance with the method for calculating the default zoom speed illustrated in FIG. 10A. A size 1003 indicates a maximum detection limit size. The zoom-in speed of Vi1 is associated with a subject size range of 9.6% to 6%. Additionally, Vi2 is associated with subject sizes from 6% to 1.2%. Reference 1009 indicates a subject determination size serving as a reference for the calculation unit 901 to determine the subject speed, and is set to 11% here. The subject determination size can be the subject detection size included in the dead zone. Although the present embodiment takes a value obtained by subtracting 1% from the target size as the subject determination size, the determination method is not limited thereto, and another method may be used as long as the resulting value is smaller than the target size.

The zoom speed in FIG. 10A is the same as that in FIG. 7A, and thus the zoom speed correction according to the second embodiment may be performed. However, only the method for correcting the zoom speed according to the present embodiment will be described here, and the correction of the zoom speed according to the second embodiment will not be described.

In FIG. 10A, for a subject size 1001, a subject size 1005 at the edge of the dead zone is 9.6%, a subject size 1006 at the maximum-side edge of the dead zone is 14.4%, and a subject size 1002 at the detection limit is 6%. The subject determination size 1009 is set when the first difference is greater than or equal to the third threshold Dth3. For example, assuming the third threshold Dth3 is 3%, the aforementioned first difference is greater than the third threshold Dth3, and thus the subject determination size 1009 is set. In this case, the calculation unit 901 calculates the subject speed v. If the subject speed v is faster than a predetermined speed, e.g., a threshold speed Sth, the subject size is changed (1015, 1017, 1018) according to the switching positions for the zoom speeds Vi2, and Vi3 (1005, 1007, and 1008) as indicated in the speed table 1010 illustrated in FIG. 10B, the zoom speed itself is also increased from Vi1 to Vi1′, from Vi2 to Vi2′, and from Vi3 to Vi3′, and the dead zone 1014 is set to a range of 10% to 14.4% of the subject size. This makes it possible to secure a zoom speed corresponding to the moving subject, which in turn makes it possible to avoid situations where the subject is lost. On the other hand, if the subject speed v is lower than the predetermined speed, e.g., is lower than the threshold speed Sth, the speed table 1000 illustrated in FIG. 10A is used.

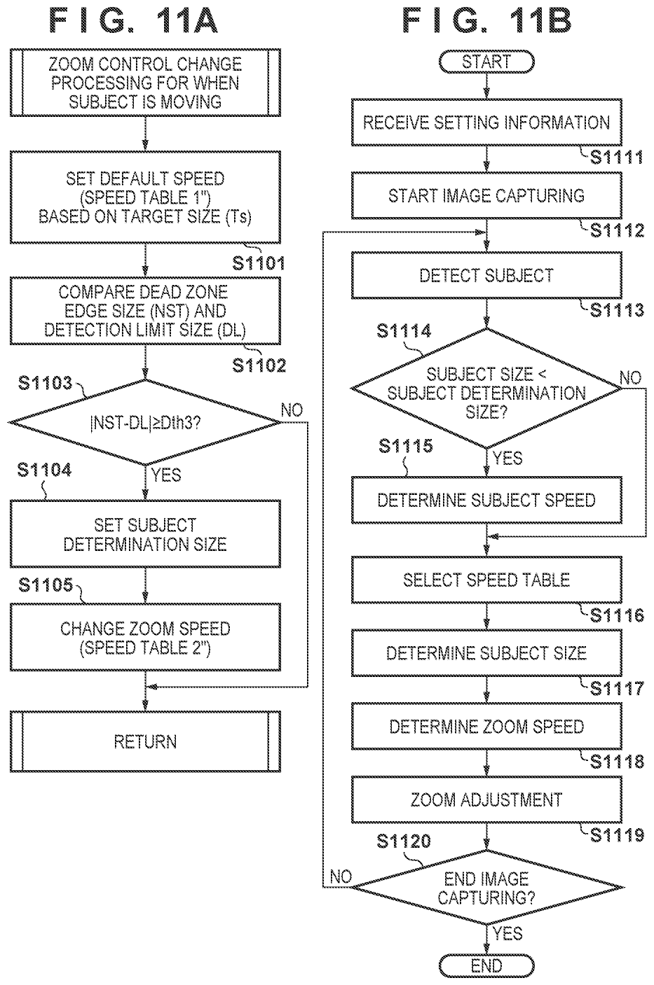

The processing by which the client device 14 generates the setting information for the network camera 100 according to the present embodiment is similar to that illustrated in FIG. 5A. However, in the present embodiment, the specifics of the processing for setting the zoom control information in step S503 are different, and will therefore be described with reference to FIG. 11A. FIG. 11A is a flowchart according to a variation on the processing for setting the zoom control information performed in step S503 of FIG. 5A, and can be executed instead of or in addition to the processing for setting the zoom control information illustrated in FIG. 5B or FIG. 8.

First, in step S1101, the CPU 201 sets the default zoom speed based on the target size (Ts). The example illustrated in FIG. 10A, for example, corresponds to the example of the zoom speed setting here. The default speed table set here will be called a speed table 1″. Additionally, when the target size (Ts) is set, the subject size (NST) 1005 on the edge of the dead zone can be specified.

Next, in step S1102, the CPU 201 compares the subject size (NST) on the edge of the dead zone, specified from the target size, with the subject size (DL) at the detection limit. If the comparison indicates that the first difference (D1) between NST and DL is greater than or equal to the third threshold Dth3 (“YES” in step S1103), the processing moves to step S1104. On the other hand, if the first difference is less than the third threshold Dth3 (“NO” in step S1103), the processing ends, and the sequence then moves to step S504. In this case, the subject determination size is not set, and the subject speed is also not calculated by the calculation unit 901.

In step S1104, the subject determination size is set. As described above, in the present embodiment, the subject determination size can be set to a value obtained by subtracting 1% from the target size (Ts), for example. Then, in step S1105, a speed table 2″ is generated by changing the zoom speed from the default speed table 1″ set in step S1101. The sequence then moves to step S504. As illustrated in FIG. 10B, in the speed table 2″ generated at this time, the subject size corresponding to the zoom-in speed switching position is different from the subject size corresponding to the switching position illustrated in FIG. 10A, and the zoom speed itself is also rising in each speed interval. Additionally, the zoom speed at the subject size corresponding to the detection limit is set to the maximum speed (Vi3′ in FIG. 10B).

In the present embodiment, the network camera 100 performs zoom control by switching between the two tables based on the subject speed. Accordingly, in step S504 of FIG. 5A, the information in the speed table 1″ in the speed table 2″ is included in the zoom control information, and in step S505, the two speed tables, the subject determination size, and the speed information on the threshold speed Sth are included in the setting information and transmitted to the network camera 100. Note that like the processing illustrated in FIGS. 5B and 8, the processing illustrated in FIGS. 11A and 11B may also be executed not on the client device 140 side, but on the network camera side, in response to the target size setting information being received, in the same manner as FIG. 5B.

Processing performed on the network camera 100 side according to the present embodiment will be described next with reference to the flowchart in FIG. 11B. The processing corresponding to this flowchart can be realized, for example, by at least one processor in the network camera 100 executing a corresponding program (which is stored in the RAM, the HD, or the like).

In step S1111, the communication unit 135 of the network camera 100 receives the setting information from the client device 140 over the network 150. The communication unit 135 supplies the received setting information to the setting information input unit 131. The setting information input unit 131 provides information for identifying the subject, among the received setting information, to the detection unit 132. Additionally, the information on the target size, the subject determination size, the threshold speed Sth, and the zoom control information (the speed table 1 and the speed table 2) are provided to the zoom determination unit 133.

Then, in step S1112, when imaging is started, the image capturing device 110 provides the image information, obtained by imaging the imaging region, to the detection unit 132 of the information processing device 130. In step S1113, the detection unit 132 detects a subject based on the information for identifying the subject, provided from the setting information input unit 131. The information on the detected subject is provided to the zoom determination unit 133 along with the image information. This image information is transmitted to the client device 140 over the network 150, through the zoom determination unit 133, the control unit 134, and the communication unit 135.

In step S1114, the zoom determination unit 133 determines the subject size based on the information on the subject provided from the detection unit 132, and determines whether the subject size is smaller than the subject determination size. If the subject size is smaller than the subject determination size (“YES” in step S1114), the processing moves to step S1115. On the other hand, if the subject size is greater than or equal to the subject determination size (“NO” in step S1114), the processing moves to step S1116.

In step S1115, the zoom determination unit 133 provides the subject information and the image information to the calculation unit 901, causes the subject speed v to be calculated, and obtains the subject speed v from the calculation unit 901. The zoom determination unit 133 holds the images of a plurality of frames prior to the current frame as well as an image of the current frame, and provides these images to the calculation unit 901 as image information for determining the subject speed v. Upon receiving the subject speed v from the calculation unit 901, the zoom determination unit 133 compares the subject speed v with the threshold speed Sth and determines the magnitude of the subject speed v. Then, in step S1116, the zoom determination unit 133 selects a speed table from among the speed table 1″ and the speed table 2″ according to the magnitude relationship between the subject speed v and the threshold speed Sth. Specifically, the speed table 2″ is selected when the subject speed v is greater than the threshold speed Sth, and the speed table 1″ is selected when the subject speed v is less than or equal to the threshold speed Sth.

Once the speed table is selected, the zoom determination unit 133 determines the subject size in step S1117, and in step S1118, determines the zoom speed by referring to the speed table selected in step S1116 based on the determined subject size. In step S1119, the zoom determination unit 133 provides the determined zoom speed to the control unit 134, and the control unit 134 controls the zoom driving device 120 to operate at the designated zoom speed. Then, in step S1120, if the imaging is to end (“YES” in step S1120), this processing ends, whereas if the imaging is not to end (“NO” in step S1120), the processing returns to step S1113 and continues.

Although the descriptions given with reference to FIG. 11B describe the details of step S1114 as basically being a comparison between the subject size and the subject determination size, the embodiment is not intended to be limited thereto. For example, if the subject determination size has not been set in the processing corresponding to FIG. 11A performed by the client device 140, the subject determination size will not be provided to the network camera 100. In such a case, the determinations made in steps S1114, S1115, and S1116 may be skipped, and the speed table 1″ may be selected as the default speed table.

As described thus far, according to the present embodiment, when the subject speed is greater than or equal to a certain speed, control is performed to change the boundary position of the zoom speed and raise the zoom-in speed. Although the boundary position of the boundary zoom speed is changed at the same time as the zoom-in speed is increased in the present embodiment, it is also possible to perform either of these alone. The method for raising the zoom speed near the detection limit is not limited to the above-described method, and another method may be used as long as the purpose of raising the zoom speed near the detection limit can be achieved.

According to the present embodiment, the subject determination size can be determined in advance based on the relationship between the set target size and the subject size at the detection limit. Then, when the subject size is changing in the direction of the detection limit and has dropped below the subject determination size, raising the zoom speed near the detection limit makes it possible to reduce situations where the subject is lost due to detection failure. The present embodiment is particularly useful in situations where the subject is moving away from the network camera 100.

### OTHER EMBODIMENTS

Embodiments can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiments and/or that includes one or more circuits (e.g., application specific integrated circuit (ASIC)) for performing the functions of one or more of the above-described embodiments, and by a method performed by the computer of the system or apparatus by, for example, reading out and executing the computer executable instructions from the storage medium to perform the functions of one or more of the above-described embodiments and/or controlling the one or more circuits to perform the functions of one or more of the above-described embodiments. The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2022-182796, filed on Nov. 15, 2022, which is hereby incorporated by reference herein in its entirety.

What is claimed is:

1. An information processing device comprising:
a detection unit configured to detect a predetermined subject from an image captured by an image capturing unit;
a determination unit configured to determine a speed at which to change an imaging range of the image capturing unit in accordance with a subject size of the predetermined subject detected; and
a control unit configured to control the change in the imaging range of the image capturing unit at the speed determined by the determination unit,
wherein the detection unit has a detection limit subject size at which the predetermined subject can be detected, and
the determination unit:
determines the speed such that the imaging range is not changed while the subject size detected takes a value within a first range determined based on a target size; and
in a case where a first difference between the detection limit subject size and a subject size associated with an edge of the first range is lower than a first predetermined value, changes the subject size associated with the edge of the first range such that the first difference becomes greater than or equal to the first predetermined value.

2. The information processing device according to claim 1,
wherein the determination unit:
determines to switch the speed from a plurality of speeds including a first speed and a second speed, in accordance with the subject size; and
in a case where a second difference between the subject size when switching between the first speed and the second speed and the detection limit subject size is lower than a second predetermined value, the subject size when switching is changed such that the second difference becomes greater than or equal to the second predetermined value.

3. The information processing device according to claim 2, further comprising:
a calculation unit configured to calculate a movement speed of the predetermined subject,
wherein the determination unit switches the speed at a larger subject size when the movement speed calculated is faster than a predetermined speed than when the movement speed is less than or equal to the predetermined speed.

4. The information processing device according to claim 3,
wherein the determination unit includes:
a first speed table having a change speed for the imaging range, the first speed table being selected when the movement speed calculated is less than or equal to the predetermined speed; and
a second speed table having a change speed for the imaging range, the second speed table being selected when the movement speed calculated is faster than the predetermined speed; and
the first speed table has a change speed associated with the detection limit subject size as a third speed, and the second speed table has a change speed associated with the detection limit subject size as a fourth speed that is faster than the third speed.

5. The information processing device according to claim 4,
wherein the second speed table is configured to satisfy at least one of the following:
in the second speed table, the change speed associated with each of the subject sizes detected is faster than the corresponding change speed associated with each of the subject sizes detected in the first speed table; and
a subject size when switching the speed in the second speed table is larger than a subject size when switching the change speed in the first speed table.

6. The information processing device according to claim 4,
wherein the second speed table is configured such that the change speed associated with the detection limit subject size is a fastest change speed in the second speed table.

7. The information processing device according to claim 3,
wherein the calculation unit calculates the movement speed when the subject size is smaller than a predetermined subject size.

8. The information processing device according to claim 7,
wherein the predetermined subject size is included in the first range.

9. The information processing device according to claim 7,
wherein the determination unit compares the subject size with the predetermined subject size when the first difference is greater than or equal to a third predetermined value, and causes the calculation unit to calculate the movement speed when the subject size is smaller than the predetermined subject size, and
the third predetermined value is a value greater than the first predetermined value.

10. The information processing device according to claim 1,
wherein the subject size is determined based on a ratio of a width of the predetermined subject to a width of the image captured by the image capturing unit.

11. An image capturing device comprising:
an image capturing unit;
a communication unit configured to communicate with an external client device; and
an information processing device, including:
a detection unit configured to detect a predetermined subject from an image captured by the image capturing unit;
a determination unit configured to determine a speed at which to change an imaging range of the image capturing unit in accordance with a subject size of the predetermined subject detected; and
a control unit configured to control the change in the imaging range of the image capturing unit at the speed determined by the determination unit,
wherein the detection unit has a detection limit subject size at which the predetermined subject can be detected, and
the determination unit:
determines the speed such that the imaging range is not changed while the subject size detected takes a value within a first range determined based on a target size; and
in a case where a first difference between the detection limit subject size and a subject size associated with an edge of the first range is lower than a first predetermined value, changes the subject size associated with the edge of the first range such that the first difference becomes greater than or equal to the first predetermined value.

12. A client device configured to be capable of communicating with the image capturing device according to claim 11, the client device comprising:
an accepting unit configured to accept a designation of a target size for a predetermined subject captured by the image capturing unit of the image capturing device;
a generation unit configured to generate speed information that associates a speed for changing an imaging range of the image capturing unit with a subject size of the predetermined subject, based on the target size; and
a communication unit configured to transmit setting information including the target size and the speed information to the image capturing device, and receive the image captured by the image capturing device,
wherein the generation unit generates the speed information by:
determining, based on the target size, a first range of the subject size at which the imaging range is not to be changed; and
in a case where a first difference between the subject size corresponding to an edge of the first range and a detection limit subject size for a subject in the image capturing device is lower than a first predetermined value, changing the subject size associated with the edge of the first range such that the first difference becomes greater than or equal to the first predetermined value in the first range.

13. The client device according to claim 12,
wherein the association with the subject size in the speed information is made for any of a plurality of speeds including a first speed and a second speed, and
in a case where a second difference between the subject size when switching between the first speed and the second speed and the detection limit subject size is lower than a second predetermined value, the generation unit generates the speed information by changing the subject size when switching such that the second difference becomes greater than or equal to the second predetermined value.

14. The client device according to claim 12,
wherein the generation unit generates the following to include in the setting information:
a predetermined subject size for determining the subject size when the first difference is greater than a third predetermined value;
a first speed table having a change speed for the imaging range, the first speed table being selected when a movement speed of the predetermined subject is less than or equal to a predetermined speed; and
a second speed table having the change speed for the imaging range, the second speed table being selected when the movement speed is faster than the predetermined speed, and
wherein the first speed table has a change speed associated with the detection limit subject size as a third speed, and the second speed table has a change speed associated with the detection limit subject size as a fourth speed that is faster than the third speed.

15. The client device according to claim 14,
wherein the second speed table is configured to satisfy at least one of the following:
in the second speed table, the change speed associated with each of the subject sizes detected is faster than the corresponding change speed associated with each of the subject sizes detected in the first speed table; and
a subject size when switching the change speed in the second speed table is larger than a subject size when switching the change speed in the first speed table.

16. A client device configured to be capable of communicating with the image capturing device according to claim 11, the client device comprising:
an accepting unit configured to accept a designation of a target size for a predetermined subject captured by the image capturing unit of the image capturing device;
a generation unit configured to generate speed information that associates a speed for changing a imaging range of the image capturing unit with a subject size of the predetermined subject, based on the target size; and
a communication unit configured to transmit setting information including the target size and the speed information to the image capturing device, and receive the image captured by the image capturing device,
wherein the generation unit determines, based on the target size, a first range of the subject size at which the imaging range is not to be changed, and
in a case where a first difference between the subject size corresponding to an edge of the first range and a detection limit subject size for a subject in the image capturing device is lower than a first predetermined value, the accepting unit further accepts a modification to the target size designated such that the first difference becomes greater than or equal to the first predetermined value.

17. A client device configured to be capable of communicating with the image capturing device according to claim 11, the client device comprising:
an accepting unit configured to accept a designation of a target size for a predetermined subject captured by the image capturing unit of the image capturing device;
a generation unit configured to generate speed information that associates a speed for changing a imaging range of the image capturing unit with a subject size of the predetermined subject, based on the target size; and
a communication unit configured to transmit setting information including the target size and the speed information to the image capturing device, and receive the image captured by the image capturing device,
wherein the generation unit determines, based on the target size, a first range of the subject size at which the imaging range is not to be changed, and
the accepting unit accepts the target size at which a first difference between the subject size corresponding to an edge of the first range and a detection limit subject size of the subject in the image capturing device is greater than or equal to a first predetermined value.

18. A control method for an information processing device,
wherein the information processing device includes:
a detection unit configured to detect a predetermined subject from an image captured by an image capturing unit;
a determination unit configured to determine a speed at which to change an imaging range of the image capturing unit in accordance with a subject size of the predetermined subject detected; and
a control unit configured to control a change in the imaging range of the image capturing unit at the speed determined by the determination unit, and
the detection unit having a detection limit subject size at which the predetermined subject can be detected,
the control method comprising:
determining, by the determination unit, the speed such that the imaging range is not changed while the subject size detected takes a value within a first range determined based on a target size; and
in a case where a first difference between the detection limit subject size and a subject size associated with an edge of the first range is lower than a first predetermined value, changing, by the determination unit, the subject size associated with the edge of the first range such that the first difference becomes greater than or equal to the first predetermined value.

19. A control method for a client device configured to be capable of communicating with the image capturing device according to claim 11,
wherein the client device includes:
an accepting unit configured to accept a designation of a target size for a predetermined subject captured by the image capturing unit of the image capturing device;
a generation unit configured to generate speed information that associates a speed for changing an imaging range of the image capturing unit with a subject size of the predetermined subject, based on the target size; and
a communication unit configured to transmit setting information including the target size and the speed information to the image capturing device, and receive the image captured by the image capturing device,
the control method comprising:
determining, by the generation unit, a first range of the subject size at which the imaging range is not to be changed in the speed information, based on the target size; and
in a case where a first difference between the subject size corresponding to the edge of the first range and a detection limit subject size for a subject in the image capturing device is lower than a first predetermined value, changing, by the generation unit, the subject size associated with the edge of the first range such that the first difference becomes greater than or equal to the first predetermined value, for the first range.

20. A non-transitory computer-readable storage medium storing one or more program including instructions that, when executed by a processor of an information processing device including a detection unit configured to detect a predetermined subject from an image captured by an image capturing unit, a determination unit configured to determine a speed at which to change an imaging range of the image capturing unit in accordance with a subject size of the predetermined subject detected, and a control unit configured to control the change in the imaging range of the image capturing unit at the speed determined by the determination unit, with the detection unit having a detection limit subject size at which the predetermined subject can be detected, cause the information processing device to:
determine the speed such that the imaging range is not changed while the subject size detected takes a value within a first range determined based on a target size; and
in a case where a first difference between the detection limit subject size and a subject size associated with an edge of the first range is lower than a first predetermined value, change the subject size associated with the edge of the first range such that the first difference becomes greater than or equal to the first predetermined value.

21. A non-transitory computer-readable storage medium storing one or more program including instructions that, when executed by a processor of a client device that is configured to be capable of communicating with the image capturing device according to claim 11 and that includes an accepting unit configured to accept a designation of a target size for a predetermined subject captured by the image capturing unit of the image capturing device, a generation unit configured to generate speed information that associates a speed for changing an imaging range of the image capturing unit with a subject size of the predetermined subject, based on the target size, and a communication unit configured to transmit setting information including the target size and the speed information to the image capturing device, and receive the image captured by the image capturing device, cause the client device to:
determine, by the generation unit, a first range of the subject size at which the imaging range is not to be changed in the speed information, based on the imaging target size; and
in a case where a first difference between the subject size corresponding to the edge of the first range and a detection limit subject size for a subject in the image capturing device is lower than a first predetermined value, change, by the generation unit, the subject size associated with the edge of the first range such that the first difference becomes greater than or equal to the first predetermined value, for the first range.
